(19) United States
(12) Patent Application Publication
(10) Pub. No.: US 2023/0052201 A1
(43) Pub. Date: Feb. 16, 2023

(54) DC EXCITED BRUSHED MOTOR WITH A PLUGGABLE SUPPRESSOR FOR THE COMMUTATION SYSTEM AND SLIDING ROOF WITH SUCH A MOTOR

(71) Applicant: NIDEC Motors & Actuators (Germany) GmbH, Bietigheim-Bissingen (DE)

(72) Inventors: Tanja SIELER, Ingersheim (DE); Christian SIELER, Ingersheim (DE); Rainer BRUHN, Ingersheim (DE)

(21) Appl. No.: 17/886,631

(22) Filed: Aug. 12, 2022

(30) Foreign Application Priority Data
Aug. 13, 2021 (DE) 20 2022 101 720.4
Mar. 31, 2022 (DE) 10 2022 107 753.5

(51) Int. Cl. H02K 13/00; H02K 5/22

(52) U.S. Cl. CPC H02K 13/006; H02K 5/225; B60J 7/02

(57) ABSTRACT

A DC-excited brushed motor includes a commutation system with a commutator with vanes uniformly distributed in a circumferential direction and at least two brushes which interact with the vanes, to connect the brushes to a DC voltage network via connecting leads. The commutation system is in a metal housing of the motor, and the motor includes an interference suppressor for the commutation system including an interference suppression choke and a capacitor for each connection lead, and the connection leads include an EMC shield between a connection for the respective capacitor and a housing passage through the metal housing of the motor.

### CROSS REFERENCE TO RELATED APPLICATIONS

This application claims the benefit of priority to German Patent Application No. 202022101720.4 filed on Aug. 13, 2021 and German Application No. 102022107753.5 filed on Mar. 31, 2022. The entire contents of these applications are hereby incorporated herein by reference.

### FIELD OF THE INVENTION

The present disclosure relates to a DC-excited brushed motor with an interference suppression device for a commutation system and to a sliding roof having such a motor.

### BACKGROUND

In DC-excited brushed motors, current is supplied from the power supply or the control device via brushes which are applied to the commutator, which is divided into several vanes and serves to turn the current. The vanes are insulated from each other at the circumference of the commutator and, when the rotor formed by the armature windings, motor shaft and commutator rotates, they are supplied with current via the brushes in corresponding succession. Here, each brush from one lamina subsequently reaches the insulated intermediate area or groove between two laminae, simultaneously contacting and shorting or bridging the two adjacent laminae, resulting in a change in the current signal. These motors cause radiated and conducted interference, which determines the electromagnetic compatibility of the motor. In many applications, the radiated interference must be below specified limits. Known specifications are, e.g., CISPR 25 Level 5 and VW81000. To reduce the interference radiation, it is known to use interference suppression components such as chokes and capacitors.

### SUMMARY

Example embodiments of the present disclosure provide DC-excited brushed motors each with an interference suppression device for a commutation system, the shielding of which is particularly effective and is also easy to install.

A DC-excited brushed motor according to an example embodiment of the present disclosure includes a commutation system with a commutator including vanes uniformly or substantially uniformly distributed in a circumferential direction and at least two brushes (for example, exactly two) cooperating with the vanes.

The brushes can be connected to a DC power supply via connecting leads. The commutation system is housed in a metal housing of the motor and the motor includes an interference suppression device for the commutation system, which includes an interference suppression choke and a capacitor for each connection lead. As part of the interference suppression device, the connecting leads between a terminal for the respective capacitor and a housing passage through the metal housing of the motor include EMC shielding. The electromagnetic interference can be reduced effectively and particularly inexpensively by the shielding.

The connecting cables each include a conductor which is surrounded in the EMC shielding by an insulation and an electromagnetic shielding surrounding the insulation on the outside. This EMC shielding has, among other things, a feedthrough capacitor effect and protects against the absorption of new radiation-bound interference.

Because, in addition, the EMC shielding of the connecting leads and/or an EMC shielding of a commutator arrangement is electrically conductively contacted with a shielding of a busbar arrangement, the shielding is particularly completely formed.

The shielding is further improved if the connecting leads and/or the busbar arrangement each include a conductor or busbars that is or are surrounded in the EMC shielding by insulation and an electromagnetic shield surrounding the insulation on the outside.

The shielding can be connected directly to ground or have an overmold of a shielding plastic that is electrically connected to the motor ground.

Simple and secure fastening and contacting of the electric motor is made possible if the busbar arrangement has a fastening region, in particular a fork-shaped fastening region, with a first arm and a second arm, the first arm carrying a first insulation displacement contact and the second arm carrying a second insulation displacement contact.

Preferably, the shield is attached to the outside of an insulating plastic of the busbar arrangement. Then the insulating plastic with particularly suitable mechanical properties can be produced by injection molding.

Electrical safety, in particular operational safety, is achieved if the shielding on the outside of the busbar arrangement is at a distance of about 0.5 mm to about 5 mm, in particular about 0.5 mm to about 2 mm, and preferably about 0.5 mm to about 1 mm from the insulation displacement contacts. In this way, accidental electrical connections between the busbars and the shielding, for example, due to contamination, can also be avoided.

Particularly simple and safe assembly is possible if the busbar arrangement is inserted into a recess in the base body of the commutator arrangement. The busbar arrangement is preferably held in the recess by friction or positive locking, in particular by latching.

To complete the electromagnetic shielding, it is particularly advantageous if the busbar arrangement in the recess has a surface electrical contact with the base body of the commutator arrangement, which is also externally shielded and connected to ground.

For further mounting and electrical contacting, it is advantageous if the busbar arrangement includes a shielded extension in which the busbars are guided away from the commutator arrangement parallel or substantially parallel to the axis of rotation of the motor. In particular, it is preferred if the extension and the mounting area are integral with each other.

The shielding is preferably connected to ground or includes an overmold of a shielding plastic. The shielding plastic preferably includes a metallic component and can also include a carbon fiber component, which produces the same shielding effect as metal.

The interference can be kept even lower if the interference suppression chokes are arranged directly behind the brushes and are thus as close as possible to the point of interference.

It is advantageous if the connecting leads each include a branch in the form of an outlet lead after the interference suppression choke, the outlet lead leading out of the metal housing and the capacitor of the interference suppression device being arranged in each of the outlet leads. The capacitor is connected to ground or to the ground of the metal housing.

To keep the interference as low as possible, the distance in the connecting leads between the suppressor choke and the capacitor is also minimal.

The brushes are preferably provided on a brush holding plate on which the electronic components are also mounted. In this case, it is advantageous if the entire brush holding plate has a symmetrical arrangement, with the axis of symmetry passing centrally through the opposing brushes (two brushes) and lying centrally from the connecting leads. In other words, the interference suppression components of the suppression device, the brushes and the leads are arranged in mirror symmetry to avoid oscillations.

To short-circuit high-frequency interference, the interference suppression device preferably includes a capacitor with a varistor or TVS diode arranged in parallel between the connecting leads to reduce voltage peaks. The leads between the connecting leads do not have to be shielded, since they do not lead to the outside and thus do not transmit interference pulses to the leads.

Several projections can be provided on the extension, on which the metal housing of the motor is supported and thus holds the busbar unit under pretension. Since the conductive coating also covers these projections, a ground connection of the shielding is thus provided at several points. Preferably, a ground connection is provided at least at the respective end regions of the busbars, but further contacting points can be provided in between.

The conductive coating can include both metal and an electrically conductive plastic. The coating can also be multilayered, so the lowest layer can be a particularly good conductive layer or have good adhesion to plastic, which is covered by another conductive layer that is in turn more resistant to mechanical or chemical attack.

It is also possible that the coating is covered by an insulating protective layer (paint), which is only recessed at the ground connection points. The coating could also include an elastic conductive plastic, which then has a large-area contact with the metal housing.

Furthermore, a sliding roof with a DC-excited brushed motor described above is provided. It is particularly important for sliding roofs in motor vehicles to comply with limits for electromagnetic interference radiation. The use in vehicle seats and the like is also conceivable.

The above and other elements, features, steps, characteristics and advantages of the present disclosure will become more apparent from the following detailed description of the example embodiments with reference to the attached drawings.

### BRIEF DESCRIPTION OF THE DRAWINGS

Example embodiments of the present disclosure are explained in more detail below with reference to the drawings.

FIG. 1 shows a circuit arrangement of a DC-excited brushed motor with interference suppression device.

FIG. 2 shows a busbar arrangement for connecting the motor to a power supply.

FIG. 3 shows a busbar arrangement from FIG. 2 in a side view.

FIG. 4 shows the busbar assembly in cross-section along line C-C of FIG. 3.

FIG. 5 shows the busbar arrangement of FIG. 2 in a view from below.

FIG. 6 shows a commutation unit of a brushed electric motor with an inserted busbar arrangement corresponding to FIG. 2 to FIG. 5.

### DETAILED DESCRIPTION

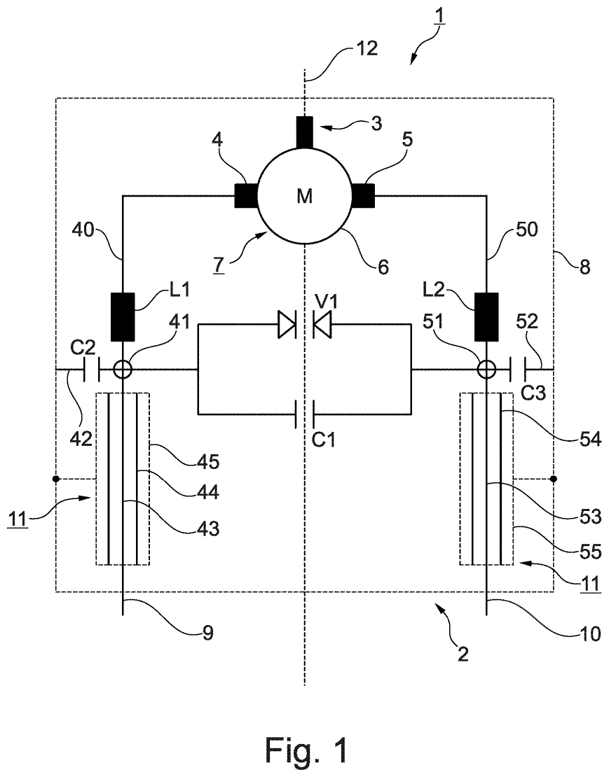

FIG. 1 shows a circuit arrangement of a DC excited brushed motor 1 with interference suppression device 2. The motor 1 is a permanent magnet excited motor with a stator 3 symbolically shown in the form of a permanent magnet and a rotor 7 fed via two brushes 4,5 and a commutator 6. The motor 1 is arranged in a metallic motor housing 8 (dashed line). A DC voltage, e.g., in the form of a PWM signal, is applied to the two brushes 4,5 by a control device not shown. The power supply is outside the motor housing. A first brush 4 is connected to a first pole, not shown, via a first connecting lead 40, and a second brush 5 is connected to a second pole, not shown, of a DC voltage network via a second connecting lead 50. The electromagnetic disturbances caused by the motor 1 are essentially caused by its commutation system with the brushes 4,5 and the commutator 6. The brushes 4,5 running on the vanes of the commutator 6, which are not shown in the drawing, each cause current-carrying gas discharges with very short current rise times and thus high-frequency interference radiation by interrupting the rotor current when a brush 4,5 runs off a commutator vane. The interference suppression device 2 described below is used to comply with the prescribed limits for electromagnetic interference radiation.

A first interference suppression choke L1 is arranged in the first connection lead 40 immediately after the first brush 4. A second interference suppression choke L2 is also inserted in the second connecting lead 50 immediately after the second brush 5. The interference suppression chokes L1,L2 are thus installed as close as possible to the point of interference. Directly behind the interference suppression chokes L1,L2, a node 41,51 is provided in each case, in which an outlet lead 42,52 branches off from the connecting leads 40,50. The outlet leads 42,52 lead out of the metal-shielded area of the motor housing 8. The connection leads 42,52 lie within the motor housing 8 up to a respective housing passage 9,10 in the motor housing 8. A capacitor C2, C3 is arranged in each of the outlet leads 42,52 within the motor housing, which is connected to ground or which is connected to the ground of the motor housing. Starting from the two nodes 41,51, a bypass capacitor C1 is provided between the two connecting leads 40,50 for short-circuiting high-frequency interference. A varistor V1 is arranged in parallel with capacitor C1 for this purpose. Between the nodes (capacitor connection) 41,51 and the housing passage 9,10, the connecting leads have an EMC (electromagnetic compatibility) shield 11. The conductor of the connecting leads 43,53 is surrounded by an insulation 44,54. For insulation, polyurethane or polyvinyl chloride (PVC) are usually used as materials, since these are inexpensive and heat-resistant while providing good insulation. However, other polymer plastics can also be used as long as they meet the requirements. The insulation 44, 54 is surrounded by a shielding 45, 55. The shielding 45, 55 can be, for example, a shielding braid of copper and/or a wound metal foil. Vapor-deposited coatings may also achieve the shielding effect. The shielding 45, 55 is connected to ground or has a corresponding connection to the ground of the motor housing. The EMC shielding 11 diverts the interference radiation to ground. In addition, the EMC shielding 11 acts as a feedthrough capacitor.

It is also possible not to bond the shielding to ground and instead use an overmold of a special shielding plastic, which also gives good results.

The brushes 4,5 are preferably arranged on a brush holding plate on which the electronic components are also mounted. Here, it is advantageous if the entire brush holding plate has a mirror-symmetrical arrangement, with the axis of symmetry lying centrally through the opposing brushes and centrally from the connecting leads. In other words, the interference suppression components of the suppression device, the brushes, and the leads are arranged in a mirror symmetrical manner to avoid oscillations. The dashed line illustrates the axis of symmetry 12.

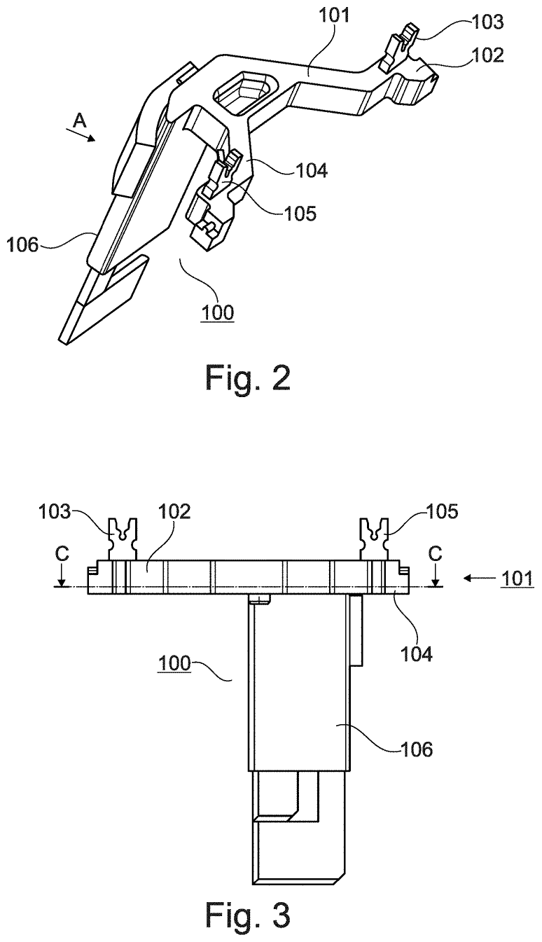

A bus bar arrangement 100 shown in perspective in FIG. 2 is provided to further improve shielding and to facilitate contacting of the electric motor in an assembly.

The busbar arrangement 100 has a motor-side mounting area 101, which in the present case is fork-shaped and carries a first insulation displacement contact 103 on a first arm 102, and has a second insulation displacement contact 105 on a second arm 104. The insulation displacement contacts 103 and 105 are designed in a known manner, in particular as IDC contacts, in such a way that they can be contacted directly with connecting leads of motor windings or commutator units, in this case with the connecting leads coming from the housing passages 9 and 10 of the motor housing. Further, the bus bar assembly 100 has an extension 106 in which bus bars not shown here are arranged. The fastening area 101 and the extension 106 of the busbar arrangement 100 are constructed in such a way that they contain busbars inside in the form of electrical conductors, in particular as stamped bent portions made of copper sheet, which are led out in the area of the insulation displacement contacts 103 and 105, and which for electromagnetic shielding are first encapsulated with an insulating plastic, which is then in turn encapsulated or electrically conductively coated with an electrically conductive plastic, as described in more detail above with respect to FIG. 1.

In FIG. 3, the busbar arrangement 100 of FIG. 2 is shown in a side view approximately in the direction of view of the directional arrow A of FIG. 2. The components already described are marked with the same reference numerals. In FIG. 3, a horizontal section line C-C is shown which indicates a cross-section through the mounting area 101 of the conductor rail arrangement 100.

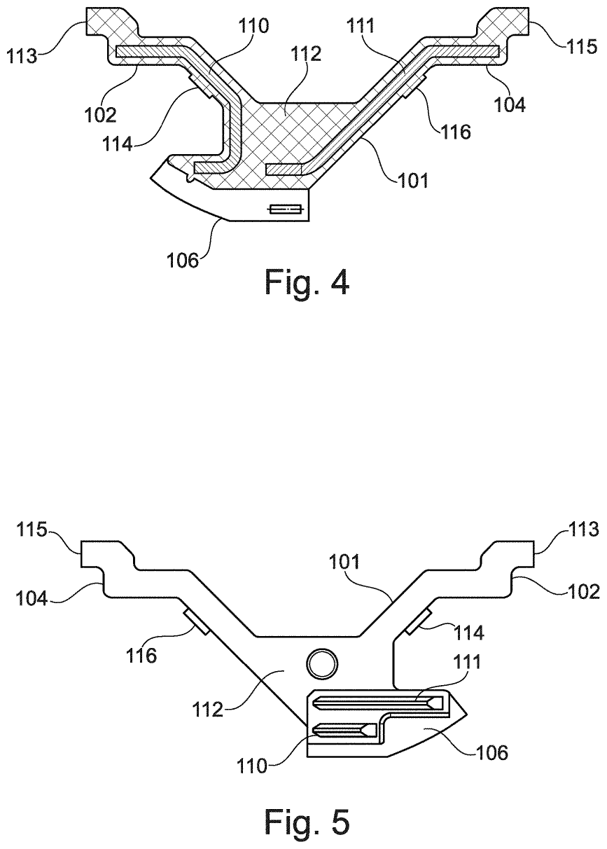

FIG. 4 shows the attachment area 101 in a plan view in cross-section along the line C-C of FIG. 3. In this cross-sectional view, a first busbar 110 is visible, which is located in the arm 102 and extends from the insulation displacement contact 103, not shown here, into the extension 106. Correspondingly, a second busbar 111 is located in the arm 104 and extends from the second insulation displacement contact 105 into the extension 106. The two busbars 110 and 111 are embedded in an electrically non-conductive plastic 112, which is injection molded to form the basic shape of the busbar assembly 100.

The first arm 102 also includes a free end 113, and a latching lug 114 not fully visible here. Correspondingly, the second arm 104 in turn includes a free end 115 and an incompletely shown latching lug 116.

While the plastic 112 is electrically non-conductive, the outer surface of the component shown is provided with an electrically conductive, EMC-shielding coating, which is either formed as a further plastic layer in the multi-component injection molding process, or which has been produced by painting, vapor deposition or similar process steps. The layer can be metallic or otherwise electrically conductive, for example, due to a high carbon content. In this case, areas in which connection elements connected to the busbars 110 and 111, in particular the insulation displacement contacts 103 and 105, are led out of the base body are excluded from the electrically conductive surface coating. The electrically conductive coating ends at a distance from these contacts to ensure sufficient electrical insulation between the contacts and the outer coating.

In FIG. 5, the busbar arrangement 100 is shown in a bottom view. Identical components are again marked with identical reference numerals. Again, the lathing lugs 114 and 116 are not fully visible. However, FIG. 5 shows the portions of busbars 110 and 111 extending downwardly (with respect to the representation in FIG. 3) through extension 106, which can be electrically contacted at the end portions visible here when the electric motor correspondingly provided with busbar arrangement 100 is mounted in an assembly.

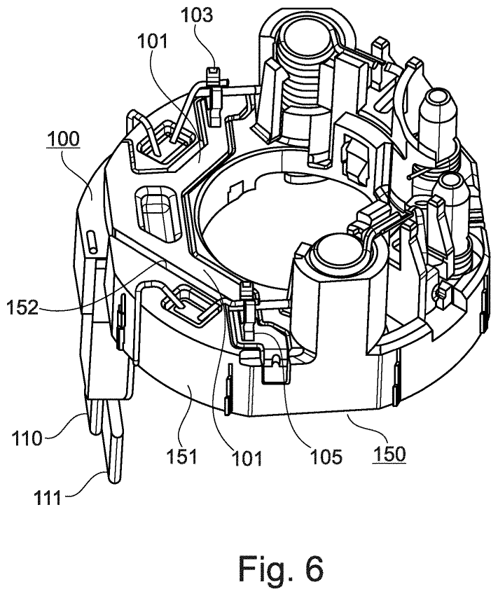

Finally, FIG. 6 shows a commutator arrangement 150 for a brushed electric motor in a perspective view. The busbar arrangement 100 is here inserted into a base body 151 of the commutator arrangement 150, with the fork-shaped region 101 inserted into a corresponding recess 152. The insulation displacement contacts 103 and 105 are connected to the electrical connecting wires of the commutator arrangement 150 and are thus in electrically conductive connection with the busbars 110 and 111. The latching lugs 114 and 116, which are not visible here, secure the busbar arrangement 100 in the base body 151 of the commutator arrangement 150. At the same time, the physical, surface contact of the busbar arrangement 100 with the base body 151 effects a secure electrical ground contact of the outer, electrically conductive surface of the busbar arrangement 100 with the ground of the electric motor and the commutator arrangement 150. This also applies in particular to the shielding of the connecting leads 40, 50 shown in FIG. 1 and their shielding 45, 55, which are connected in this way to the shielding of the busbar arrangement 100.

The busbar arrangement 100 thus represents a separate component for the manufacture of the electric motor, which is easy to assemble, which is itself electromagnetically shielded, and which enables simple and safe electrical contacting of the electric motor.

While here the two busbars 110 and 111 are combined in a common component, it may also be envisaged, depending on the application, that each busbar is contained in a separate component, in which case each busbar is also surrounded by an insulating plastic, and the insulating plastic is coated on the outside in an electrically conductive manner in order to build up an electromagnetic shield.

In another example embodiment, it may be provided that the bus bars themselves are provided with a thin electrical insulation, for example, an insulating lacquer, and the outer electrically conductive layer is formed as a relatively thick layer of injection molding compound or the like which determines the shape of the bus bar arrangement. Independently, the outer surface of the component may also be further protected against external influences by an anti-corrosion coating, wherein one or more locations of the surface of the electrically conductive coating are exposed to come into contact with the base body 151 of the commutator arrangement 150. Electrical contact between the busbar arrangement and the commutator arrangement in the region of the outer surfaces of the shielding can be promoted not only by fitting the components into one another and latching them together or by press-fitting them, but also by joining the components together with a certain pretension, the pretension mechanically pressing the contact surfaces of the electromagnetic shielding on both sides against one another. Large-surface contact areas are generally advantageous.

While example embodiments of the present disclosure have been described above, it is to be understood that variations and modifications will be apparent to those skilled in the art without departing from the scope and spirit of the present disclosure. The scope of the present disclosure, therefore, is to be determined solely by the following claims.

What is claimed is:

1. A DC-excited brushed motor comprising:
a metal housing;
a commutation system in the metal housing and including a commutator with vanes uniformly distributed in a circumferential direction and at least two brushes which interact with the vanes, to connect the at least two brushes to a DC voltage network via connecting leads;
an interference suppressor for the commutation system including connection leads each including an interference suppression choke and a capacitor, the connection leads being between a connection for the respective capacitor and a housing passage through the metal housing; wherein
an EMC shielding of the connection leads and/or an EMC shielding of a commutator assembly is electrically conductively contacted with a shielding of a busbar assembly.

2. The DC-excited brushed motor of claim 1, wherein the connection leads and/or the busbar assembly each include a conductor or busbars, respectively, surrounded in the EMC shielding by an insulation and an electromagnetic shielding surrounding the insulation on an outside circumference.

3. The DC excited brushed motor of claim 2, wherein the shielding is connected to ground or includes an overmold of a shielding plastic.

4. The DC-excited brushed motor of claim 1, wherein the busbar assembly includes a mounting portion a bifurcated mounting portion including a first arm and a second arm, the first arm carrying a first insulation displacement contact and the second arm carrying a second insulation displacement contact.

5. The DC excited brushed motor of claim 1, wherein the shielding is provided on an outer surface of an insulating plastic of the busbar assembly.

6. The DC-excited brushed motor of claim 1, wherein a distance between the shielding of the busbar assembly to the insulation displacement contacts is about 0.5 mm to about 5 mm.

7. The DC excited brushed motor of claim 1, wherein the bus bar assembly is inserted into a recess of a base body of the commutator assembly.

8. The DC-excited brushed motor of claim 7, wherein the busbar assembly is held in the recess in a frictional lock or positive lock.

9. The DC excited brushed motor of claim 7, wherein the bus bar assembly includes a surface electrical contact with the base body of the commutator assembly in the recess.

10. The DC excited brushed motor of claim 1, wherein the bus bar assembly includes a shielded extension in which the bus bars are routed away from the commutator assembly parallel or substantially parallel to an axis of rotation of the motor.

11. The DC-excited brushed motor of claim 10, wherein the shielded extension and a mounting portion of the busbar assembly are integral with each other.

12. The DC excited brushed motor of claim 10, wherein the shielded extension includes a plurality of integral projections against which the metal housing is supported to maintain the bus bar assembly under bias.

13. A sliding roof comprising the DC excited brushed motor according to claim 1.

14. A vehicle seat comprising the DC excited brushed motor according to claim 1.
